(19) United States
(12) Patent Application Publication
(10) Pub. No.: US 2021/0392928 A1
(43) Pub. Date: Dec. 23, 2021

(54) LIQUID FOR FLESH PROCESSING

(71) Applicant: J-OIL MILLS, INC., Tokyo (JP)

(72) Inventors: Kenta KATO, Tokyo (JP); Tsukasa KASAHARA, Tokyo (JP); Sanshiro SAITO, Tokyo (JP)

(21) Appl. No.: 17/279,143

(22) PCT Filed: Sep. 19, 2019
(86) PCT No.: PCT/JP2019/036807

§ 371 Date: Mar. 24, 2021

(30) Foreign Application Priority Data
Sep. 28, 2018 (JP) 2018-185925

(51) Int. Cl. A23L 13/70; A23L 13/40; A23L 13/50; A23L 17/40

(52) U.S. Cl. CPC A23L 13/70; A23L 13/432; A23L 17/40; A23L 13/52; A23L 13/422

(57) ABSTRACT

Provided is a liquid for meat processing, including (A) an oil- or fat-processed starch and (B) one or more alkali agents selected from the group consisting of sodium hydrogen carbonate, sodium carbonate, potassium hydrogen carbonate, and potassium carbonate, in which a pH of a 10% by mass aqueous dispersion of the component (A) at 25° C. is equal to or more than 4.0 and equal to or less than 12.0.

### TECHNICAL FIELD

The present invention relates to a liquid for meat processing.

### BACKGROUND ART

As a technique for improving the quality of meat processed products, it is known in the related art that a moisture content of meat can be maintained by adding a phosphate and the elasticity of meat is thus increased, leading to a soft texture. In addition, as other techniques for improving the quality of a meat processed food, there are techniques described in Patent Documents 1 and 2.

In Patent Document 1 (Japanese Unexamined Patent Publication No. 2007-6724), as a technique having an object to provide a quality improver for meat to be added to a raw material meat in order to suppress deterioration of a texture of meat after retort sterilization in a retort pouch food in which meat is encapsulated alone or together with other food materials, a quality improver for meat, which includes an oil- or fat-processed starch containing an oil or fat and a glycerol organic acid fatty acid ester, and a powdery curdlan having an average particle diameter of 0.05 to 50 μm, is described. In addition, as a method of adding such an improver to meat, a method of using an improver which has been dispersed in a pickling liquid is described.

In Patent Document 2 (Japanese Unexamined Patent Publication No. 2009-112269), a method for treating fish and seafood using an oil- or fat-processed starch containing an oil or fat and a glycerol organic acid fatty acid ester is described, in which the fish and seafood treated by such a treatment method is considered to alleviate a decrease in a yield due to heat-cooking and to have an excellent texture after heat-cooking. In addition, as a method using an oil- or fat-processed starch for fish and seafood, a method of soaking fish and seafood in a solution containing an oil- or fat-processed starch is described in the same document.

### RELATED DOCUMENT

### Patent Document

[Patent Document 1] Japanese Unexamined Patent Publication No. 2007-6724

[Patent Document 2] Japanese Unexamined Patent Publication No. 2009-112269

### SUMMARY OF THE INVENTION

### Technical Problem

Here, with respect to the above-mentioned phosphate, there has recently been a concern about unpreferable effects on health in recent years, and food manufacturers also tend to avoid the use of phosphoric acid. However, it has been clarified by the studies by the present inventors that there is room for improvement in obtaining a meat processed food having excellent workability at the time of the production, which can impart a preferable texture and a natural taste with no unpleasant taste during chewing after putting the teeth in a meat processed food in a case where a phosphate is not blended.

### Solution to Problem

According to the present invention, a liquid for meat processing, a composition for a liquid for meat processing, a method for producing a meat processed food, and a method for improving chewiness of a meat processed food, each as described below, are provided.

[1] A liquid for meat processing, including the following components (A) and (B):

(A) an oil- or fat-processed starch; and

(B) one or more alkali agents selected from the group consisting of sodium hydrogen carbonate, sodium carbonate, potassium hydrogen carbonate, and potassium carbonate,

in which a pH of a 10% by mass aqueous dispersion of the component (A) at 25° C. is equal to or more than 4.0 and equal to or less than 12.0.

[2] The liquid for meat processing as described in [1],

in which a phosphate is not substantially included.

[3] The liquid for meat processing as described in [1] or [2],

in which a content of the component (A) with respect to a content of the component (B) is equal to or more than 0.1 and equal to or less than 40 in terms of a mass ratio.

[4] The liquid for meat processing as described in any one of [1] to [3],

in which the component (A) is an oil- or fat-processed distarch phosphate from tapioca starch.

[5] The liquid for meat processing as described in any one of [1] to [4],

in which the component (B) is sodium hydrogen carbonate.

[6] The liquid for meat processing as described in any one of [1] to [5], further including a component (C): a pregelatinized starch.

[7] The liquid for meat processing as described in [6],

in which a content of the component (A) with respect to a content of the component (C) is equal to or more than 1 and equal to or less than 40 in terms of a mass ratio.

[8] The liquid for meat processing as described in any one of [1] to [7],

in which the meat is one or more selected from the group consisting of chicken, pork, beef, prawns, white fish, squid, and scallops.

[9] A powdery composition for a liquid for meat processing, including the following components (A) and (B):

(A) an oil- or fat-processed starch; and

(B) one or more alkali agents selected from the group consisting of sodium hydrogen carbonate, sodium carbonate, potassium hydrogen carbonate, and potassium carbonate,

in which a pH of a 10% by mass aqueous dispersion of the component (A) at 25° C. is equal to or more than 4.0 and equal to or less than 12.0.

[10] The composition for a liquid for meat processing as described in [9],

in which the component (A) and the component (B) are contained in a total amount of equal to or more than 25% by mass and equal to or less than 100% by mass with respect to the entire composition for meat processing.

[11] The composition for a liquid for meat processing as described in [9] or [10],

in which a content of the component (A) with respect to a content of the component (B) in the composition for meat processing is equal to or more than 0.1 and equal to or less than 40 in terms of a mass ratio.

[12] The composition for a liquid for meat processing as described in any one of [9] to [11], further including a component (C): a pregelatinized starch.

[13] The composition for a liquid for meat processing as described in [12],

in which a content of the component (A) with respect to a content of the component (C) is equal to or more than 1 and equal to or less than 40 in terms of a mass ratio.

[14] A method for producing a meat processed food, including applying a liquid for meat processing, including the following components (A) and (B), to meat:

(A) an oil- or fat-processed starch; and

(B) one or more alkali agents selected from the group consisting of sodium hydrogen carbonate, sodium carbonate, potassium hydrogen carbonate, and potassium carbonate,

in which a pH of a 10% by mass aqueous dispersion of the component (A) at 25° C. is equal to or more than 4.0 and equal to or less than 12.0.

[15] The method for producing a meat processed food as described in [14],

in which a content of the component (A) with respect to a content of the component (B) in the liquid for meat processing is equal to or more than 0.1 and equal to or less than 40 in terms of a mass ratio.

[16] The method for producing a meat processed food as described in [14] or [15],

in which the applying the liquid for meat processing to meat is applying the liquid for meat processing to meat by one or more methods selected from the group consisting of injection, tumbling, soaking, spraying, and coating.

[17] The method for producing a meat processed food as described in any one of [14] to [16],

in which in the applying the liquid for meat processing to meat, the liquid for meat processing is applied so that an amount of the component (A) to be added with respect to 100 parts by mass of the meat is equal to or more than 0.1 parts by mass and equal to or less than 20 parts by mass in terms of a mass ratio.

[18] The method for producing a meat processed food as described in any one of [14] to [17],

in which the meat processed food is selected from the group consisting of grilled chicken, karaage, steamed prawns, and fried prawns.

[19] A method for improving chewiness of a meat processed food, including incorporating a liquid for meat processing into meat in production of the meat processed food, the meat processed food including the following components (A) and (B):

(A) an oil- or fat-processed starch; and

(B) one or more alkali agents selected from the group consisting of sodium hydrogen carbonate, sodium carbonate, potassium hydrogen carbonate, and potassium carbonate,

in which a pH of a 10% by mass aqueous dispersion of the component (A) at 25° C. is equal to or more than 4.0 and equal to or less than 12.0.

### Advantageous Effects of Invention

As described above, according to the present invention, it is possible to obtain a liquid for meat processing, having excellent workability at the time of the production, which can impart a preferable texture and a natural taste with no unpleasant taste during chewing after putting the teeth in a meat processed food, even in a case where a phosphate is not blended.

### DESCRIPTION OF EMBODIMENTS

Hereinafter, embodiments of the present invention will be described with reference to specific examples of each component. Further, each component may be used alone or in combination of two or more kinds thereof. In addition, in the present specification, the liquid for meat processing is also referred to as a pickling liquid.

(Liquid for Meat Processing)

In the present embodiment, the liquid for meat processing includes the following components (A) and (B).

(A) An oil- or fat-processed starch

(B) One or more alkali agents selected from the group consisting of sodium hydrogen carbonate, sodium carbonate, potassium hydrogen carbonate, and potassium carbonate,

Here, a pH of a 10% by mass aqueous dispersion of the component (A) at 25° C. is equal to or more than 4.0 and equal to or less than 12.0.

Furthermore, it is preferable that the liquid for meat processing does not substantially include a phosphate. Here, not substantially including a phosphate means that phosphate is not intentionally blended during the preparation of the liquid for meat processing. At this time, the content of the phosphate in the liquid for meat processing is preferably equal to or less than 0.01% by mass with respect to the entire liquid for meat processing.

(Component (A))

The component (A) is an oil- or fat-processed starch. The oil- or fat-processed starch is a starch-based material produced through a process in which one or more selected from the group consisting of an edible oil or fat and an analogous substance of an edible oil or fat are added to a raw material starch, and then mixed and heated.

The raw material starch for the component (A) is not limited, and examples thereof corn starch, waxy corn starch, high-amylose corn starch, potato starch, tapioca starch, wheat starch, rice starch, sago starch, sweet potato starch, green bean starch, pea starch, and a modified starch thereof such as a starch obtainable by subjecting the above-mentioned starch to one or a combination of two or more of acetylation, etherification, or crosslinking such as crosslinking by phosphoric acid and crosslinking by adipic acid.

In addition, the component (A) is preferably one or more selected from the group consisting of an oil- or fat-processed tapioca starch, an oil- or fat-processed corn starch, and an oil- or fat-processed waxy corn starch, and more preferably an oil- or fat-processed distarch phosphate from tapioca starch, from the viewpoint of improving the texture during chewing after putting the teeth in a meat processed food and from the viewpoint of enhancing the dispersibility during and after the preparation of a liquid for meat processing. Further, a tapioca starch, a corn starch, and a waxy corn starch, which are raw materials, respectively, for the oil- or fat-processed tapioca starch, the oil- or fat-processed corn starch, and the oil- or fat-processed waxy corn starch, may be a modified starch.

In addition, examples of an edible oil or fat as the raw material for the component (A) include soybean oil, safflower oil such as linoleic acid-rich safflower oil, corn oil, rapeseed oil, perilla oil, linseed oil, sunflower oil, peanut oil, cottonseed oil, olive oil, rice oil, palm oil, coconut oil, sesame oil, camellia oil, tea oil, mustard oil, kapok seed oil, kaya nut oil, walnut oil, and poppy oil.

Furthermore, as the edible oil or fat, an oil or fat having an iodine value of equal to or more than 100 is more preferably used, and an oil or fat having an iodine value of equal to or more than 140 is still more preferably used. Such an oil or fat having a high iodine value is easily oxidized by heating, has a high modifying effect of a starch, and can be expected to have a texture improving effect of a food such as a meat processed food. Specific examples of the oil or fat having an iodine value of 140 or more include linoleic acid-rich safflower oil and linseed oil, and the linoleic acid-rich safflower oil is more preferable.

In addition, examples of the analogous substance of an edible oil or fat include a monoglycerol fatty acid ester; a polyglycerol fatty acid ester such as a diglycerol monooleic acid ester; a polyglycerol condensed ricinoleic acid ester; an organic acid fatty acid ester; a sucrose fatty acid ester; a sorbitan fatty acid ester; a polysorbate; and a phospholipid. The analogous substance of an edible oil or fat is preferably the polyglycerol fatty acid ester, and more preferably the diglycerol monooleic acid ester, from the viewpoint of improving the texture during chewing after putting the teeth in a meat processed food and from the viewpoint of enhancing the dispersibility during and after the preparation of a liquid for meat processing.

Here, the blending amount of the edible oil or fat or the analogous substance of an edible oil or fat at the time of the preparation of an oil- or fat-processed starch is set so that a total amount of the edible oil or fat and the analogous substance of an edible oil or fat is, for example, equal to or more than 0.005 parts by mass, preferably equal to or more than 0.008 parts by mass, and still more preferably equal to or more than 0.02 parts by mass with respect to 100 parts by mass of a raw material starch, from the viewpoint of more reliably obtaining a modifying effect of the starch. Further, the blending amount of the edible oil or fat or the analogous substance of an edible oil or fat with respect to 100 parts by mass of a raw material starch is set so that a total amount of the edible oil or fat and the analogous substance of an edible oil or fat is, for example, equal to or less than 2 parts by mass, preferably equal to or less than 1.5 parts by mass, and still more preferably equal to or less than 0.8 parts by mass, from the viewpoint of a texture improving effect.

Furthermore, a combination of a starch and an edible oil or fat which are each used for the production of an oil- or fat-processed starch is preferably a combination of one or more selected from the group consisting of a crosslinked tapioca starch, an acetylated tapioca starch, a tapioca starch, a corn starch, and a waxy corn starch, and an oil or fat having an iodine value of 100 or more, such as linoleic acid-rich safflower oil and linseed oil, and preferably a combination of the crosslinked tapioca starch and the linoleic acid-rich safflower oil, from the viewpoint of improving the texture during chewing after putting the teeth in a meat processed food.

Moreover, components other than the above-mentioned components may be used as a raw material for the oil- or fat-processed starch, and examples thereof include soybean flour such as whole fat soybean flour and defatted soybean flour.

Next, a method for producing the component (A) will be described.

The method for producing the oil- or fat-processed starch of the component (A) includes, for example, the following steps:

preparing a mixture by blending one or more selected from the group consisting of an edible oil or fat and an analogous substance of an edible oil or fat with raw material starch, and

subjecting the mixture obtained in the preparing a mixture to a heating treatment.

Here, in the preparing a mixture, the mixture may be configured to include a pH adjuster from the viewpoint of suppressing the oxidized odor of the oil- or fat-processed starch.

The pH adjuster may be any pH adjuster that can be used in foods, and can be selected according to the types of a raw material starch and an edible oil or fat, but is preferably a hydroxide such as sodium hydroxide, potassium hydroxide, calcium hydroxide, and magnesium hydroxide; a carbonate such as sodium carbonate, sodium hydrogen carbonate, and potassium carbonate; a phosphate such as disodium hydrogen phosphate and sodium dihydrogen phosphate; and an organic acid salt other than the above-mentioned salts, such as trisodium citrate, sodium acetate, sodium lactate, disodium succinate, sodium gluconate, sodium tartrate, and sodium fumarate from the viewpoints of a solubility in water and an effect of the taste and the like on a final product, and one or more of those salts are preferably blended. One or more of carbonates such as sodium carbonate, sodium hydrogen carbonate, and potassium carbonate are more preferably used, and one or more selected from the group consisting of sodium carbonate and trisodium citrate are still more preferably used.

In addition, a pH adjuster having a pH of equal to or more than 6.5 at 25° C. in a 1% by mass aqueous solution is preferably used, a pH adjuster having the pH of equal to or more than 8.0 is more preferably used, and a pH adjuster having the pH of equal to or more than 10 is still more preferably used, from the viewpoint of more effectively suppressing the oxidized odor of an oil- or fat-processed starch.

The amount of the pH adjuster to be added at the time of the preparation of an oil- or fat-processed starch is, for example, equal to or more than 0.005 parts by mass, preferably equal to or more than 0.02 parts by mass, and more preferably equal to or more than 0.03 parts by mass with respect to 100 parts by mass of the starch, from the viewpoint of suppressing the oxidized odor of the component (A). In addition, the amount of the pH adjuster to be added is, for example, equal to or less than 2 parts by mass, preferably equal to or less than 1.5 parts by mass, still more preferably equal to or less than 1.2 parts by mass, and even still more preferably equal to or less than 1 part by mass with respect to 100 parts by mass of the starch, from the viewpoint of suppressing the occurrence of astringent taste in a meat processed food.

In addition, the amount of the pH adjuster to be added can be adjusted so that the pH of the mixture is, for example, about 6.5 to 10.9, and preferably about 6.5 to 10.5.

The pH of the mixture is a pH value measured by a glass electrode method from a starch slurry having a concentration of 10% by mass, which has been prepared from the mixture obtained in the preparing a mixture described above.

The pH adjuster is preferably added in a case of mixing a starch and an oil or fat. A method for adding the pH adjuster is not limited, and a salt may be added as it is, but it is preferable that the pH adjuster is dissolved in advance in water in the amount of about 1 to 10 times the amount of the salt, and then a salt solution thus obtained is added. It is more preferable that the pH adjuster is dissolved in water in the amount of equal to or more than 0.1 parts by mass and equal to or less than 10 parts by mass with respect to 100 parts by mass of the raw material starch, and then a solution therefrom is added. A damage to the starch due to heating can be suppressed more stably by making the pH adjuster into an aqueous solution in advance.

In addition, the order of addition of the pH adjuster in the preparing a mixture is not limited, and thus, the pH adjuster may be added after mixing a raw material starch with an edible oil or fat or an analogous substance of an edible oil or fat; or the edible oil or fat or the analogous substance of an edible oil or fat may be added after adding the raw material starch and the pH adjuster. From the viewpoint of workability, it is preferable to add the pH adjuster after mixing the raw material starch with the edible oil or fat or the analogous substance of an edible oil or fat.

Next, the subjecting the mixture to a heating treatment will be described.

In the subjecting the mixture to a heating treatment, an oil- or fat-processed starch can be obtained by heating the mixture obtained in the preparing a mixture.

With regard to the heating treatment, for example, in a case of heating and roasting at a high temperature of equal to or higher than 150° C., there is a concern that the viscosity of a starch may decrease due to a damage to the starch granules and the original water retention of the starch may be lost. Thus, there is a concern that by adding to a meat processed food, a decrease in a yield may cause, and the like. Therefore, the heating treatment is performed at a low temperature of preferably equal to or lower than 130° C., and more preferably lower than 120° C., and is still more preferably performed at a low temperature of about 40° C. to 110° C. By performing such a heating treatment, the damage of the starch is suppressed and the meat improving effect is enhanced. It should be noted that the lower limit of the heating temperature is not limited, but is set to, for example, equal to or higher than 40° C. from the viewpoint of appropriately shortening the heating period and improving the productivity.

The period of the heating treatment is appropriately set according to the state of the starch and the heating temperature, and is, for example, equal to or more than 0.5 hours and equal to or less than 25 days, preferably equal to or more than 5 hours and equal to or less than 20 days, and more preferably equal to or more than 6 hours and equal to or less than 18 days.

From the above, the component (A) can be obtained.

The pH of a 10% by mass aqueous dispersion of the component (A) at 25° C. (hereinafter also simply referred to as “the pH of the component (A)”) is equal to or more than 4.0, preferably equal to or more than 4.5, more preferably equal to or more than 5.5, still more preferably equal to or more than 6.0, and even still more preferably equal to or more than 8.0, from the viewpoint of improving the dispersibility at the time of the production of a pickling liquid.

In addition, the pH of the component (A) is equal to or less than 12.0, preferably equal to or less than 11.0, more preferably equal to or less than 10.0, and still more preferably equal to or less than 9.5, from the viewpoint of imparting a natural taste with no unpleasant taste.

The content of the component (A) in the liquid for meat processing is preferably equal to or more than 0.2% by mass, more preferably equal to or more than 0.5% by mass, still more preferably equal to or more than 0.8% by mass, and even still more preferably equal to or more than 2% by mass with respect to the entire liquid for meat processing, from the viewpoint of improving the chewiness at the time of chewing and suppressing dryness.

In addition, from the viewpoint of improving the chewiness at the time of chewing, the content of the component (A) in the liquid for meat processing is preferably equal to or less than 8% by mass, more preferably equal to or less than 6% by mass, and still more preferably equal to or less than 4% by mass with respect to the entire liquid for meat processing.

(Component (B))

The component (B) is one or more alkali agents selected from the group consisting of sodium hydrogen carbonate, sodium carbonate, potassium hydrogen carbonate, and potassium carbonate.

From the viewpoint of suppressing the unpleasant taste of the meat processed food, the component (B) preferably includes one or more selected from the group consisting of sodium hydrogen carbonate and potassium hydrogen carbonate, more preferably includes sodium hydrogen carbonate, and still more preferably includes sodium hydrogen carbonate (sodium bicarbonate). It should be noted that sodium hydrogen carbonate, sodium carbonate, potassium hydrogen carbonate, and potassium carbonate as the pH adjuster in the production of an oil- or fat-processed starch are not included in the component (B).

The content of the component (B) in the liquid for meat processing is preferably equal to or more than 0.1% by mass, more preferably equal to or more than 0.2% by mass, still more preferably equal to or more than 0.5% by mass, and even still more preferably equal to or more than 0.8% by mass with respect to the entire liquid for meat processing, from the viewpoint of improving the initial chewiness of a meat processed food.

In addition, the content of the component (B) in the liquid for meat processing is preferably equal to or less than 5% by mass, more preferably equal to or less than 3.5% by mass, and still more preferably equal to or less than 2% by mass with respect to the entire liquid for meat processing, from the viewpoint of suppressing the unpleasant taste.

Furthermore, the content of the component (A) with respect to the content of the component (B) in the liquid for meat processing, that is, ((A)/(B)) is preferably equal to or more than 0.1, more preferably equal to or more than 0.5, and still more preferably equal to or more than 1.2 in terms of a mass ratio, from the viewpoint of suppressing the unpleasant taste.

In addition, the mass ratio ((A)/(B)) is, for example, equal to or less than 40, preferably equal to or less than 15, more preferably equal to or less than 8, still more preferably equal to or less than 6, and even still more preferably equal to or less than 4, from the viewpoint of improving the initial chewiness.

(Water)

Specifically, the liquid for meat processing includes water. The content of water in the liquid for meat processing can be, for example, a balance excluding the content of components other than water, included in the liquid for meat processing.

Furthermore, the content of water in the liquid for meat processing may be, for example, equal to or more than 80% by mass, preferably equal to or more than 85% by mass, more preferably equal to or more than 90% by mass, and still more preferably equal to or more than 92% by mass, from the viewpoint of suppressing the unpleasant taste of the meat processed food.

The content of water in the liquid for meat processing may be, for example, equal to or less than 99.7% by mass, preferably equal to or less than 99% by mass, and more preferably equal to or less than 98% by mass, from the viewpoint of improving the texture, the taste of the meat processed food, and the workability at the time of the production of the meat processed food.

Since the liquid for meat processing in the present embodiment includes the above-mentioned specific components (A) and (B), it is suitably used in meat, and it is possible to obtain a meat processed food which has excellent workability at the time of the production while having an excellent balance between a preferable texture and a taste during chewing after putting the teeth in a meat processed food. For example, according to the present embodiment, it is also possible to obtain a meat processed food which has a suppressed unpleasant taste while having an excellent balance of a preferable springiness at the time of putting the teeth in a meat processed food at first, an appropriate resistance during chewing, and a non-dry or moist feeling.

(Other Components)

The liquid for meat processing may include components other than the components (A) and (B), and water.

For example, the liquid for meat processing may further include the following component (C).

Component (C): Pregelatinized starch

Here, the component (C) is a starch other than the component (A). Further, the pregelatinized starch is a starch that has been pregelatinized, and examples of the pregelatinization treatment method include a jet cooker treatment, a drum dryer treatment, and an extruder treatment. Further, the pregelatinized starch of the component (C) also includes a partially pregelatinized starch.

By making the liquid for meat processing configured to further include the component (C), the workability at the time of the production of a meat processed food can be improved. For example, by making the liquid for meat processing configured to further include the component (C), it is possible to improve the dispersibility of the liquid for meat processing, and thus, it is also possible to make the liquid for meat processing applied to the surface of a chunk of meat into a uniform state.

The amylose content of the component (C) is preferably equal to or more than 30% by mass, and more preferably equal to or more than 40% by mass, from the viewpoint of improving the dispersibility at the time of the preparation of a liquid for meat processing, and is equal to or less than 100% by mass.

Furthermore, as an index of the degree of pregelatinization of the component (C), a degree of swelling in cold water can be used. A method for measuring the degree of swelling in cold water will be described later in the section of Examples.

The degree of swelling in cold water of the component (C) is preferably equal to or more than 3, and more preferably equal to or more than 4 in terms of dry matter, from the viewpoint of improving the workability at the time of the production of a meat processed food.

In addition, the degree of swelling in cold water of the component (C) is preferably equal to or less than 40, more preferably equal to or less than 30, still more preferably equal to or less than 20, and even still more preferably equal to or less than 15 in terms of dry matter, from the viewpoint of improving the initial chewiness of a meat processed food.

Specific examples of the component (C) include one or more starches selected from the group consisting of a pregelatinized waxy starch, a pregelatinized high-amylose corn starch, and a pregelatinized corn starch. The component (C) is preferably the pregelatinized high-amylose corn starch from the viewpoint of improving the initial chewiness.

In a case where the liquid for meat processing includes the component (C), the content of the component (A) with respect to the content of the component (C) in the liquid for meat processing, that is, ((A)/(C)) is preferably equal to or more than 1, more preferably equal to or more than 1.5, still more preferably equal to or more than 3, and even still more preferably equal to or more than 5 in terms of a mass ratio, from the viewpoint of improving the initial chewiness of a meat processed food.

In addition, the mass ratio ((A)/(C)) is preferably equal to or less than 40, more preferably equal to or less than 20, still more preferably equal to or less than 15, and even still more preferably equal to or less than 13, from the viewpoint of improving the chewiness at the time of chewing of a meat processed food.

Moreover, the liquid for meat processing may include components other than the components (A) to (C), and water. Specific examples of such a component include starches (sodium octenyl succinate starch and the like) other than the components (A) and (C);

seasonings such as a salt, sugar, and monosodium glutamate;

liquid seasonings such as a soy sauce, a vinegar, an oil or fat, a sake, and a mirin;

spices such as nutmeg, pepper, garlic powder, ginger powder, and turmeric powder;

color developers such as sodium nitrite;

preservatives such as sodium sorbate, glycine, and Na acetate;

antioxidants such as sodium ascorbate;

coloring materials such as a cochineal colorant;

emulsifiers such as sodium casein;

thickening stabilizers such as xanthan gum, locust bean gum, and guar gum; and

nutritional enhancers such as calcined shell calcium, eggshell calcium, and calcium carbonate. In addition, components usually used in foods such as protein materials and flavors may be included.

(Meat)

In the present embodiment, specific examples of meat to which a liquid for meat processing is applied include meat of mammals such as cows, pigs, lambs, and goats;

meat of birds represented by poultry such as chickens, ducks, turkeys, geese, and ducks;

reptiles such as crocodiles;

amphibians such as frogs; and

meat of fish and seafood such as meat of fish exemplified by white fish, prawns, squid, and scallops, in which the meat is preferably meat of one selected from the group consisting of chicken, pork, beef, and fish and seafood. These may be used alone or in combination of two or more kinds thereof. The meat is more preferably meat of one or more selected from the group consisting of chicken, pork, beef, prawns, white fish, squid, and scallops.

Furthermore, the meat as a raw material for a meat processed food is preferably chunky meat, and specific examples thereof include fillet-shaped meat such as thinly sliced meat and thickly sliced meat; block-shaped meat; meat that is used as a raw material itself is, such as prawns; and meat that is cut to a certain size, such as fish fillets.

In addition, the meat which is a raw material for the meat processed food in the present embodiment is preferably not minced, and more preferably in a volume of equal to or more than 1 cm³.

(Meat Processed Food)

In the present embodiment, the meat processed food can be obtained by using the above-mentioned liquid for meat processing in the present embodiment.

Specific examples of the meat processed food include grilled, deep-fried, karaage, and steamed food of various types of meat. It is preferable that the meat processed food is selected from the group consisting of grilled chicken, karaage (deep-fried food) including karaage of meat, steamed prawns, and deep-fried prawns from the viewpoint of improving the taste and the texture at the time of applying a liquid for meat processing.

(Composition for Liquid for Meat Processing)

In the present embodiment, the composition for a liquid for meat processing is powdery and contains the above-mentioned components (A) and (B). The composition for a liquid for meat processing is suitably used for the preparation of a liquid for meat processing. Specific examples and blending amounts of the components (A) and (B) are as described above for the liquid for meat processing.

In addition, the mass ratio ((A)/(B)) of the content of the component (A) with respect to the content of the component (B) in the composition for a liquid for meat processing is preferably within the range described above for the liquid for meat processing.

The composition for a liquid for meat processing may further include the above-mentioned component (C). Specific examples of the component (C) are as described above for the liquid for meat processing.

In addition, the mass ratio ((A)/(C)) of the content of the component (A) with respect to the content of the component (C) in the composition for a liquid for meat processing is preferably within the range described above for the liquid for meat processing.

Furthermore, the composition for a liquid for meat processing may include powdery components other than the components (A) to (C). Specific examples of such a component include starches (sodium octenyl succinate starch and the like) other than the components (A) and (C);

seasonings such as a salt, sugar, and monosodium glutamate;

spices such as nutmeg, pepper, garlic powder, ginger powder, and turmeric powder;

color developers such as sodium nitrite;

preservatives such as sodium sorbate, glycine, and Na acetate;

antioxidants such as sodium ascorbate;

coloring materials such as a cochineal colorant;

emulsification stabilizers such as sodium casein;

thickening stabilizers such as xanthan gum, locust bean gum, and guar gum; and

nutritional enhancers such as calcined shell calcium, eggshell calcium, and calcium carbonate.

In addition, components usually used in foods such as protein materials and flavors may be included.

A total of the content of the component (A) and the content of the component (B) in the composition for a liquid for meat processing is preferably equal to or more than 25% by mass, more preferably equal to or more than 40% by mass, still more preferably equal to or more than 60% by mass, and even still more preferably equal to or more than 70% by mass with respect to the entire composition for a liquid for meat processing, from the viewpoint of suppressing the initial chewiness and the dryness.

In addition, the total of the content of the component (A) and the content of the component (B) is equal to or less than 100% by mass, and preferably less than 100% by mass, with respect to the entire composition for a liquid for meat processing.

(Method for Producing Meat Processed Food)

In the present embodiment, the method for producing a meat processed food includes, for example, applying the above-mentioned components (A) and (B) to meat. More specifically, the method for producing a meat processed food includes applying a liquid for meat processing, including the components (A) and (B), to meat.

The applying the liquid for meat processing to meat is preferably applying the liquid by one or more methods selected from the group consisting of injection, tumbling, soaking, spraying, and coating, from the viewpoint of enhancing the production stability of a meat processed food and workability at the time of the production.

In the production method of the present embodiment, the mass ratio ((A)/(B)) is preferably equal to or more than 0.1, more preferably equal to or more than 0.5, and still more preferably equal to or more than 1.2, from the viewpoint of suppressing the unpleasant taste.

In addition, the mass ratio ((A)/(B)) is, for example, equal to or less than 40, preferably equal to or less than 15, more preferably equal to or less than 8, still more preferably equal to or less than 6, and even still more preferably equal to or less than 4, from the viewpoint of improving the initial chewiness.

Moreover, in the applying the liquid for meat processing to meat, the amount of the component (A) to be added with respect to 100 parts by mass of the meat is preferably equal to or more than 0.1 parts by mass, more preferably equal to or more than 0.5 parts by mass, and still more preferably equal to or more than 2 parts by mass, from the viewpoint of improving the chewiness at the time of chewing of a meat processed food and suppressing the dryness.

In addition, the amount of the component (A) to be added with respect to 100 parts by mass of the meat is preferably equal to or less than 20 parts by mass, more preferably equal to or less than 15 parts by mass, and still more preferably equal to or less than 10 parts by mass, from the viewpoint of improving the chewiness at the time of chewing.

Moreover, in the applying the liquid for meat processing to meat, a component (C): a pregelatinized starch may be further applied to meat.

At this time, the liquid for meat processing is applied to meat so that the content of the component (A) with respect to the content of the component (C) in the liquid for meat processing, that is, ((A)/(C)) is preferably equal to or more than 1, more preferably equal to or more than 1.5, still more preferably equal to or more than 3, and even still more preferably equal to or more than 5 in terms of a mass ratio, from the viewpoint of improving the initial chewiness.

In addition, the liquid for meat processing is applied so that the mass ratio ((A)/(C)) is preferably equal to or less than 40, more preferably equal to or less than 20, still more preferably equal to or less than 15, and even still more preferably equal to or less than 13, from the viewpoint of improving the chewiness at the time of chewing.

With regard to the meat processed food of the present embodiment, since the liquid for meat processing, including the components (A) and (B), is applied to meat, it is possible to obtain a meat processed food having excellent workability, which can impart a preferable texture and a natural taste with no unpleasant taste during chewing after putting the teeth in a meat processed food, even in a case where a phosphate is not blended.

(Method for Improving Chewiness of Meat Processed Food)

Moreover, in the present embodiment, the method for improving chewiness of a meat processed food includes adding a liquid for meat processing, including the above-mentioned components (A) and (B), to meat in the production of the meat processed food.

The method of incorporating the components (A) and (B) into meat is not limited, but is preferably a method of impregnating the components (A) and (B) into meat from the viewpoint of uniformly infiltrating the liquid for meat processing into meat, and examples of the method include a method of impregnating chunky meat with a liquid for meat processing by one or more methods selected from the group consisting of injection, tumbling, soaking, spraying, and coating.

In addition, the chewiness preferably is good chewiness at the time of chewing.

### EXAMPLES

Examples of the present invention will be shown below, but the gist of the present invention is not limited thereto.

In the following Examples, “%” is “% by mass” unless otherwise specified. In addition, the “parts” are “parts by mass” unless otherwise specified.

(Raw Materials)

The following raw materials were mainly used as raw materials.

(Starch)

Distarch phosphate from tapioca starch 1: ACTBODY TP-1, manufactured by J-Oil Mills, Inc.

Distarch phosphate from tapioca starch 2: ACTBODY TP-2, manufactured by J-Oil Mills, Inc.

Distarch phosphate from tapioca starch 3: ACTBODY TP-4W, manufactured by J-Oil Mills, Inc.

Native tapioca starch: manufactured by J-Oil Mills, Inc.

Corn starch: manufactured by J-Oil Mills, Inc.

Pregelatinized high-amylose corn starch: GELCOL AH-F, manufactured by J-Oil Mills, Inc. (degree of swelling in cold water: 6.5)

Acetylated tapioca oil- or fat-processed starch (hereinafter also referred to as “K-1”): NERIKOMI Starch K-1, manufactured by Nihon Shokuhin Kako Co., Ltd.

(Emulsifier)

Glycerol diacetyl tartaric acid fatty acid ester: POEM W-60, manufactured by Riken Vitamin Co., Ltd.

Diglycerol monooleic acid ester: RIKEMAR JV2681, manufactured by Riken Vitamin Co., Ltd.

(Others)

Defatted soybean flour: Milky S, manufactured by J-Oil Mills, Inc.

Bread crumbs: FRYSTAR 7 GOLD, manufactured by FryStar Co., Ltd.

Linoleic acid-rich safflower oil: safflower salad oil, manufactured by Summit Oil Mill Co., Ltd.

### Production Example 1

To 100 parts by mass of the distarch phosphate from tapioca starch 1 were added 0.1 parts by mass of linoleic acid-rich safflower oil, 0.05 parts by mass of a diglycerol monooleic acid ester and 0.4 parts by mass (0.1 parts by mass in terms of sodium carbonate equivalent) of a 25% aqueous sodium carbonate solution obtained by adding 30 parts by mass of water with respect to 10 parts by mass of sodium carbonate so that sodium carbonate was completely dissolved, and uniformly mixed using a mixer (Super Mixer, manufactured by Kawata Corporation) at 3,000 rpm for 3 minutes to obtain a mixture (moisture content: 14.8%). This mixture was heated at 70° C. for 10 days in a shelf dryer to obtain an oil- or fat-processed starch 1. In addition, Super Mixer (manufactured by Kawata Corporation) was used as any of the mixers in the Production Examples of the present specification.

### Production Example 2

An oil- or fat-processed starch 2 was obtained by producing an oil- or fat-processed starch by the same method as in Production Example 1, except that the amount of the diglycerol monooleic acid ester to be added was 0.1 parts by mass in Production Example 1.

### Production Example 3

An oil- or fat-processed starch 3 was obtained by producing an oil- or fat-processed starch by the same method as in Production Example 1, except that the native tapioca starch was used instead of the distarch phosphate from tapioca starch 1 in Production Example 1.

### Production Example 4

In the present Example, 1.7 parts by mass of defatted soybean flour and 0.2 parts by mass of linoleic acid-rich safflower oil were added to 100 parts by mass of a distarch phosphate from tapioca starch (a 1:1 mixture of the distarch phosphate from tapioca starch 2 and the distarch phosphate from tapioca starch 3), and the mixture was uniformly mixed with a mixer at 3,000 rpm for 3 minutes to obtain a mixture (moisture content: 14.8%). This mixture was heated at 70° C. for 14 days in a shelf dryer to obtain an oil- or fat-processed starch 4.

### Production Example 5

In the present Example, an oil- or fat-processed starch 5 was obtained by producing an oil- or fat-processed starch by the same method as in Production Example 4, except that a starch mixture (a mixture of the distarch phosphate from tapioca starch 2 and a corn starch at 1:0.95) was added instead of the distarch phosphate from tapioca starch, 2.01 parts by mass of defatted soybean flour was added, and the amount of linoleic acid-rich safflower oil was set to 0.24 parts by mass in Production Example 4.

### Production Example 6

In the present Example, an oil- or fat-processed starch 6 was obtained by producing an oil- or fat-processed starch by the same method as in Production Example 4, except that 100 parts by mass of corn starch was added instead of the distarch phosphate from tapioca starch, the amount of linoleic acid-rich safflower oil to be added was 0.1 parts by mass, and the defatted soybean flour was not added in Production Example 4.

### Production Example 7

In the present Example, an oil- or fat-processed starch 7 was obtained by producing an oil- or fat-processed starch by the same method as in Production Example 4, except that 100 parts by mass of a distarch phosphate from tapioca starch (a mixture of the distarch phosphate from 2 and the distarch phosphate from tapioca starch 3 at 1:2.15) was used, 0.3 parts by mass of trisodium citrate was added, the amount of the linoleic acid-rich safflower oil to be added was 0.3 parts by mass, and the defatted soybean flour was not added in Production Example 4.

In the present Example, the oil- or fat-processed starch was produced according to “Preparation of Oil- or Fat-Processed Starch (Trial Product A)” (paragraph 0030) of Patent Document 2.

### Production Example 8

An oil or fat composition formed of 7.5 g of a linoleic acid-rich safflower oil and 7.5 g of a glycerol diacetyl tartaric acid fatty acid ester was heated and dissolved at 60° C. 0.5 parts by mass of the oil or fat composition was added to 100 parts by mass of the distarch phosphate from tapioca starch 1 whose moisture content had been adjusted to 12.5%, and the mixture was uniformly mixed at 3,000 rpm for 10 minutes with a mixer. The obtained mixture was packed in a closed tank and subjected to a heating treatment at 60° C. for 14 days to obtain an oil- or fat-processed starch 8.

The pH's of the oil- or fat-processed starches obtained in Production Examples 1 to 8 and the above-mentioned acetylated tapioca oil- or fat-processed starch “K-1” are shown in Table 1. Here, the pH of the oil- or fat-processed starch was measured by the following method.

(pH)

A 10% by mass aqueous dispersion was prepared for each oil- or fat-processed starch, and the pH of each aqueous dispersion at 25° C. was measured by a glass electrode method.

TABLE 1

| Sample | pH |
|---|---|
| Oil- or fat-processed starch 1 | 9.0 |
| Oil- or fat-processed starch 2 | 9.2 |
| Oil- or fat-processed starch 3 | 9.2 |
| Oil- or fat-processed starch 4 | 5.8 |
| Oil- or fat-processed starch 5 | 5.6 |
| Oil- or fat-processed starch 6 | 4.6 |
| Oil- or fat-processed starch 7 | 5.7 |
| Oil- or fat-processed starch 8 | 3.5 |
| K-1 | 5.2 |

The degree of swelling in cold water of the component (C) was measured by the following method.

(Method for Measuring Degree of Swelling in Cold Water)

The degree of swelling in cold water was measured by the method described in “Starch/Related Sugar Experiment Method”, pp. 279 and 280, 1986, Gakkai Shuppan Center. Specifically, it was measured by the following method.

(1) A sample was heated and dried at 125° C., a moisture content thereof was measured using a moisture meter (Electromagnetic moisture meter: Model No. MX50, Kensei Kogyo Co., Ltd.), and the mass of the dry material was calculated from the obtained moisture value.

(2) 1 g of the sample was accurately weighed as calculated relative to the amount of the dry material, placed in a centrifuge tube, and impregnated with 1 mL of methyl alcohol, and distilled water at 25° C. was added thereto while stirring with a glass rod to adjust the amount exactly to 50 mL. The mixture was shaken occasionally and left at 25° C. for 20 minutes. The mixture was centrifuged at 4,000 rpm at 25° C. for 30 minutes with a centrifuge (Hitachi Tabletop Centrifuge CT6E type, manufactured by Hitachi Koki Co., Ltd.; rotor: T4SS type swing rotor; adapter: 50TC x 2S adapter), and the supernatant was inclined and put into a weighing bottle. The supernatant in the weighing bottle was evaporated to dryness, further dried under reduced pressure at 110° C. for 3 hours, and weighed to determine the dry mass of the supernatant. Further, the mass of the precipitated fraction was determined, the solubility was calculated by the following equation, and then the degree of swelling in cold water was calculated.

Solubility (S) db %=Dry mass (mg) of supernatant/1,000×100

Swelling degree in cold water=Precipitated mass (mg)/(1,000×(100−S)/100)

(Examples 1-1 to 1-3, Examples 2-1 to 2-3, Examples 3-1 to 3-5, Examples 4-1 to 4-3, Examples 5-1 to 5-4, Examples 6-1 to 6-4, Example 7, Comparative Examples 1 and 2, Control Examples 1-1 and 1-2, and Control Examples 2 to 6)

In the present Examples, various pickling liquids were prepared, with which steamed prawns were prepared and evaluated. The pickling liquids were prepared by blending and mixing the raw materials shown in each table for each Example in Tables 3 to 9. The production method and evaluation method of steamed prawns are shown below.

(Method for Producing Steamed Prawns)

A frozen raw prawns (Vannamei) (size standard: 51 to 60) thawed with running water was used as raw material prawns.

On the other hand, among the raw materials for a pickling liquid, the component (A) and the component (B) were mixed to prepare a powdery composition for a liquid for meat processing. Next, the composition and all the other raw materials for a pickling liquid were combined and suspended.

With regard to Tables 3 to 8, 100 parts of prawns were put in a bag with a zipper, 100 parts of a pickling liquid was added thereto, and air was removed to seal the bag.

Then, each zipper bag was placed on a bat and left to stand in a refrigerator at 4° C. for 4 hours for soaking.

In Table 9, tumbling was applied to meat, instead of the above-described standing and soaking. That is, 100 parts of prawns were put in a zipper bag, 40 parts of a pickling liquid was added, air was removed to seal the bag, and tumbling was performed at 4° C. for 120 minutes using a tumbler (RTN-VSQ0, manufactured by Daido Sangyo Co., Ltd.).

Thereafter, the contents of each zipper bag were opened, drained well, and weighed, and the yield after soaking was calculated.

Next, the prawns were arranged in a perforated hotel pan and cooked at 99° C. for 5 minutes in a low-temperature steam mode of a steam convection oven (manufactured by Maruzen Co., Ltd.; SSC-03NSTU).

Immediately after cooking with steam, the weight of the prawns was measured and the yield after steaming was calculated. Then, the yield after cooking was calculated.

Then, the prawns were cooled to room temperature (25° C.) This was used for sensory evaluation.

(Calculation of Yield after Soaking)

The yield after soaking was calculated from the weight before soaking and the weight after soaking, each obtained above, using the following equation.

Yield after soaking (%)=Weight after soaking/Weight before soaking×100

(Calculation of Yield after Steaming)

The yield after steaming was calculated from the weight before steaming and the weight after steaming, each obtained above, using the following equation.

Yield after steaming (%)=Weight after steam/Weight after soaking×100

(Calculation of Yield after Cooking)

The yield after cooking was calculated from the yield after soaking and the yield after steaming, each obtained above, using the following equation.

Yield after cooking (%)=Yield after soaking×Yield after steaming/100

(Sensory Evaluation)

The initial chewiness, the chewiness at the time of chewing, the dryness, and the taste (presence or absence of an unpleasant taste) of the steamed prawns obtained in each Example were evaluated. Each Example listed in each table other than Table 8 was evaluated by three professional panelists, and each Example listed in Table 8 was evaluated by two professional panelists. For each evaluation item, those with a score of more than 2 points were considered as acceptable. The evaluation criteria for each item are shown in Table 2.

Furthermore, in Examples other than the steamed prawns (Tables 10 and 11) which will be described later, the sensory evaluation was performed according to the evaluation of the steamed prawns for portions without notice.

In addition, in Examples shown in Tables 3 and 5, the scores were decided by the consensus of the professional panelists. Further, in Examples shown in Table 4, Table 6, Table 7, Table 8, and Table 9, the average score of each professional panelist was used as the score.

(Evaluation of Workability)

For the pickling liquid of each Example, one operator evaluated the dispersibility at the time of the preparation of a pickling liquid and the redispersibility during soaking. For each evaluation item, those with 2 points or more were accepted. The evaluation criteria for each item are shown in Table 2.

TABLE 2

| | | | | | Workability (By one operator of equal to or | | |
|---|---|---|---|---|---|---|---|
| Sensory evaluation (scores of more than 3 | | | | | more than 3 points was considered as acceptable) | | |
| points were considered as acceptable) | | | | | | Dispersibility at | |
| | Initial | Chewiness at | | | | time of preparation | Redispersibility at |
| Score | chewiness | time of Chewing | Dryness | Taste | Score | of pickling liquid | time of soaking |
| 4 | Feeling very | Feeling | Very moist | No unpleasant | 4 | Very easy to be | Not precipitated or able |
| | springy | appropriate | | taste (natural | | dispersed in water | to be dispersed |
| | | resistance to | | taste) | | without forming | immediately only by |
| | | teeth at tine | | | | lumps | lifting during |
| | | of chewing | | | | | precipitation |
| 3 | Feeling | Feeling slight | Slightly | Almost no | 3 | Easy to be | Being able to be dispersed |
| | slightly | resistance to | moist | unpleasant taste | | dispersed in water | by lifting and shaking |
| | springy | teeth at time | | | | without forming | gently during |
| | | of chewing | | | | lumps too much | precipitation |
| 2 | Not feeling | Feeling strong | Slightly | Slightly felt | 2 | Forming some lumps | Being able to be dispersed |
| | very springy | resistance/not | dry | unpleasant taste | | but being able to | by lifting and shaking |
| | | feeling much | | | | be dispersed in | during precipitation |
| | | resistance to | | | | water without | |
| | | teeth at time | | | | problems | |
| | | of chewing | | | | | |
| 1 | Not feeling | Feeling very | Very dry | Felt unpleasant | 1 | Forming many lumps | During precipitation, |
| | springy at | strong | | taste | | and taking | precipitates are |
| | all | resistance/not | | | | considerable | solidified and not able to |
| | | feeling | | | | efforts to be | be dispersed even by |
| | | resistance at | | | | dispersed in water | lifting and shaking |
| | | all to teeth at | | | | | thoroughly |
| | | time of chewing | | | | | |

TABLE 3

| | | Control | | | | Control |
|---|---|---|---|---|---|---|
| Raw materials (% by mass) for | | Example | Example | Example | Example | Example |
| pickling liquid | | 1-1 | 1-1 | 1-2 | 1-3 | 1-2 |
| Powdery | (A) Oil- or fat- | | 1% | 3% | 5% | |
| raw | processed starch 1 | | | | | |
| material | (B) Sodium hydrogen | | 1% | 1% | 1% | |
| (X) | carbonate | | | | | |
| | Polyphosphate | 1% | | | | |
| | Common salt | 3% | 3% | 3% | 3% | 3% |

| Ice water | | 96% | 97% | 97% | 97% | 97% |
|---|---|---|---|---|---|---|
| Total amount of pickling | | 100% | 100% | 100% | 100% | 100% |
| liquid (% by mass) | | | | | | |
| (A)/(B) | | — | 1.0 | 3.0 | 5.0 | — |
| ((A)/(100 parts by mass of meat)) | | 0.0 | 1.0 | 3.0 | 5.0 | 0.0 |
| ((A) + (B))/(X) | | — | 40.0% | 57.1% | 66.7% | — |
| Yield | Yield after soaking | 117% | 115% | 115% | 120% | 113% |
| | Yield after steaming | 62% | 66% | 66% | 69% | 54% |
| | Yield after cooking | 73% | 76% | 77% | 83% | 61% |
| Sensory | Initial chewiness | 2 | 4 | 4 | 4 | 2 |
| evaluation | Chewiness at time | 2 | 3 | 4 | 3 | 2 |
| | of chewing | | | | | |
| | Dryness | 3 | 3 | 4 | 4 | 1 |
| | Taste | 3 | 3 | 3 | 3 | 4 |
| Workability | Dispersibility | 4 | 4 | 4 | 4 | 4 |
| | Redispersibility | 4 | 3 | 3 | 3 | 4 |

As seen from Table 3, steamed prawns prepared by applying a liquid for meat processing, including predetermined amounts of the component (A) and the component (B), to prawns had a good texture and a good taste.

The initial chewiness and the taste were both good in a case where the content of the component (A) was equal to or more than 1% by mass and equal to or less than 5% by mass in the liquid for meat processing. The chewiness at the time of chewing was good in a case where the content of the component (A) was equal to or more than 1% by mass and equal to or less than 5% by mass, and the chewiness was better in a case where the content was 3% by mass. The suppression of dryness was good in a case where the content of the component (A) was equal to or more than 1% by mass and equal to or less than 5% by mass, and was better in a case where the content was equal to or more than 3% by mass and equal to or less than 5% by mass.

TABLE 4

| | | Control | | | |
|---|---|---|---|---|---|
| Raw materials for pickling | | Example | Example | Example | Example |
| liquid (% by mass) | | 2 | 2-1 | 2-2 | 2-3 |
| Powdery | (A) Oil- or fat- | | 3.00% | | |
| raw | processed starch 1 | | | | |
| material | (A) Oil- or fat- | | | 3.00% | |
| (X) | processed starch 2 | | | | |
| | (A) Oil- or fat- | | | | 3.00% |
| | processed starch 3 | | | | |
| | (B) Sodium hydrogen | | 1.00% | 1.00% | 1.00% |
| | carbonate | | | | |
| | Common salt | 3.00% | 3.00% | 3.00% | 3.00% |
| Ice water | | 97.00% | 93.00% | 93.00% | 93.00% |
| Total amount of pickling | | 100.00% | 100.00% | 100.00% | 100.00% |
| liquid (% by mass) | | | | | |
| (A)/(B) | | — | 3.00 | 3.00 | 3.00 |
| ((A)/(100 parts by mass of meat)) | | — | 3.00 | 3.00 | 3.00 |
| ((A) + (B))/(X) | | — | 57.1% | 57.1% | 57.1% |
| Yield | Yield after soaking | 112% | 116% | 116% | 117% |
| | Yield after steaming | 59% | 69% | 70% | 69% |
| | Yield after cooking | 66% | 80% | 82% | 80% |
| Sensory | Initial chewiness | 2.0 | 3.7 | 3.3 | 2.3 |
| evaluation | Chewiness at time | 2.3 | 4.0 | 3.0 | 3.0 |
| | of chewing | | | | |
| | Dryness | 1.0 | 4.0 | 3.3 | 2.7 |
| | Taste | 4.0 | 3.7 | 3.7 | 3.3 |
| Workability | Dispersibility | 4 | 4 | 4 | 4 |
| | Redispersibility | 4 | 3 | 3 | 3 |

TABLE 5

| Raw materials for | | Example | Example | Example | Example | Example |
|---|---|---|---|---|---|---|
| pickling liquid | | 3-1 | 3-2 | 3-3 | 3-4 | 3-5 |
| Powdery | (A) Oil- or fat- | 3.00% | | | | |
| raw | processed starch 1 | | | | | |
| material | (A) Oil- or fat- | | 3.00% | | | |
| (X) | processed starch 4 | | | | | |
| | (A) Oil- or fat- | | | 3.00% | | |
| | processed starch 5 | | | | | |
| | (A) Oil- or fat- | | | | 3.00% | |
| | processed starch 6 | | | | | |
| | (A) Oil- or fat- | | | | | 3.00% |
| | processed starch 7 | | | | | |
| | (B) Sodium hydrogen | 1.00% | 1.00% | 1.00% | 1.00% | 1.00% |
| | carbonate | | | | | |
| | Common salt | 3.00% | 3.00% | 3.00% | 3.00% | 3.00% |
| Ice water | | 93.00% | 93.00% | 93.00% | 93.00% | 93.00% |
| Total amount of pickling | | 100.00% | 100.00% | 100.00% | 100.00% | 100.00% |
| liquid (% by mass) | | | | | | |
| (A)/(B) | | 3.00 | 3.00 | 3.00 | 3.00 | 3.00 |
| ((A)/(100 parts by mass of meat)) | | 3.00 | 3.00 | 3.00 | 3.00 | 3.00 |
| ((A) + (B))/(X) | | 57.1% | 57.1% | 57.1% | 57.1% | 57.1% |
| Yield | Yield after soaking | 118% | 117% | 118% | 118% | 118% |
| | Yield after steaming | 69% | 69% | 68% | 71% | 69% |
| | Yield after cooking | 81% | 81% | 80% | 84% | 82% |
| Sensory | Initial chewiness | 4 | 3 | 3 | 3 | 3 |
| evaluation | Chewiness at time | 4 | 4 | 4 | 3 | 3 |
| | of chewing | | | | | |
| | Dryness | 4 | 4 | 4 | 4 | 4 |
| | Taste | 3 | 4 | 4 | 4 | 4 |
| Workability | Dispersibility | 4 | 3 | 3 | 2 | 4 |
| | Redispersibility | 3 | 3 | 3 | 3 | 3 |

As seen from Tables 4 and 5, the liquid for meat processing in which the pH of the component (A) was within a predetermined range had good workability, and steamed prawns prepared by applying the liquid for meat processing to prawns had a good texture and a good taste.

In a case where the pH of the component (A) was equal to or more than 4.6, a food having a suppressed dryness and a natural taste with no unpleasant taste could be obtained. Further, the chewiness at the time of chewing was good in a case where the pH of the component (A) was equal to or more than 4.6 and equal to or less than 9.2, and was better in a case where the pH was equal to or more than 5.8 and equal to or less than 9.0. The initial chewiness was good in a case where the pH of the component (A) was equal to or more than 4.6 and equal to or less than 9.2, and was better in a case where the pH was 9.0. In addition, the workability at the time of the preparation of a pickling liquid was good in a case where the pH of the component (A) was equal to or more than 4.6 and equal to or less than 9.2, was better in a case where the pH was equal to or more than 5.6 and equal to or less than 9.2, and was even better in a case where the pH was equal to or more than 9.0 and equal to or less than 9.2.

Furthermore, as seen from Table 4, in a case where a diglycerol monooleic acid ester was added during the production of an oil- or fat-processed starch, an amount of the diglycerol monooleic acid ester of 0.05 parts by mass (Example 2-1) was more preferred, as compared with the amount of 0.1 parts by mass (Example 2-2), from the viewpoints of the initial chewiness, the pleasantness of the chewiness at the time of chewing, and the suppression of dryness. In addition, a case where the distarch phosphate from tapioca starch (Examples 2-1 and 2-2) was used as a raw material starch for the oil- or fat-processed starch was preferred from the viewpoints of the initial chewiness, the pleasantness of the chewiness at the time of chewing, the suppression of dryness and the taste.

TABLE 6

| | | Control | | | | Comparative |
|---|---|---|---|---|---|---|
| Raw materials for pickling | | Example | Example | Example | Example | Example |
| liquid (% by mass) | | 3 | 4-1 | 4-2 | 4-3 | 1 |
| Powdery | (A) Oil- or fat- | | 1.00% | 2.00% | 3.00% | 4.00% |
| raw | processed starch 1 | | | | | |
| material | (B) Sodium hydrogen | | 3.00% | 2.00% | 1.00% | |
| (X) | carbonate | | | | | |
| | Common salt | 3.00% | 3.00% | 3.00% | 3.00% | 3.00% |
| Ice water | | 97.00% | 93.00% | 93.00% | 93.00% | 93.00% |
| Total amount of pickling | | 100.00% | 100.00% | 100.00% | 100.00% | 100.00% |
| liquid (% by mass) | | | | | | |
| (A)/(B) | | — | 0.33 | 1.00 | 3.00 | — |
| ((A)/(100 parts by mass of meat)) | | — | 1.00 | 2.00 | 3.00 | 4.00 |
| ((A) + (B))/(X) | | — | 57.1% | 57.1% | 57.1% | 57.1% |
| Yield | Yield after soaking | 114% | 118% | 118% | 118% | 114% |
| | Yield after steaming | 58% | 77% | 73% | 71% | 58% |
| | Yield after cooking | 66% | 91% | 86% | 83% | 67% |
| Sensory | Initial chewiness | 2.0 | 3.3 | 3.7 | 3.7 | 1.3 |
| evaluation | Chewiness at time | 2.3 | 3.0 | 3.3 | 4.0 | 2.7 |
| | of chewing | | | | | |
| | Dryness | 1.0 | 3.7 | 3.7 | 4.0 | 1.3 |
| | Taste | 4.0 | 2.7 | 3.0 | 3.7 | 3.0 |
| Workability | Dispersibility | 4 | 4 | 4 | 4 | 4 |
| | Redispersibility | 4 | 3 | 3 | 3 | 3 |

As seen from Table 6, the liquid for meat processing in which the content of the component (A) with respect to the content of the component (B) (that is, (A)/(B)) in the liquid for meat processing was within a predetermined range had good workability, and steamed prawns prepared by applying the liquid for meat processing to prawns had a good texture and a good taste.

The initial chewiness was good in a case where the value of ((A)/(B)) was equal to or more than 0.33 and equal to or less than 3.0, and was better in a case where the value was 1.0. The chewiness at the time of chewing the taste was good in a case where the value was equal to or more than 0.33 and equal to or less than 3.0, was better in a case where the value was equal to or more than 1.0 and equal to or less than 3.0, and was even better in a case where the value was 3.0. The suppression of dryness was good in a case where the value was equal to or more than 0.33 and equal to or less than 3.0, and was better in a case where the value was 3.0.

TABLE 7

| | | Control | | | Comparative | | |
|---|---|---|---|---|---|---|---|
| Raw materials for | | Example | Example | Example | Example | Example | Example |
| pickling liquid | | 4 | 5-1 | 5-2 | 2 | 5-3 | 5-4 |
| Powdery | (A) Oil- or fat- | | 3.00% | 3.00% | | 3.00% | 3.00% |
| raw | processed starch 1 | | | | | | |
| material | Oil- or fat- | | | | 3.00% | | |
| (X) | processed starch 8 | | | | | | |
| | (B) Sodium hydrogen | | 0.30% | 0.75% | 0.75% | 0.75% | 0.75% |
| | carbonate | | | | | | |
| | (C) Pregelatinized | | | | | 0.25% | 0.40% |
| | high-amylose corn | | | | | | |
| | starch | | | | | | |
| | Common salt | 3.00% | 3.00% | 3.00% | 3.00% | 3.00% | 3.00% |
| Ice water | | 97.00% | 93.70% | 93.25% | 93.25% | 93.00% | 92.85% |
| Total amount of pickling | | 100.00% | 100.00% | 100.00% | 100.00% | 100.00% | 100.00% |
| liquid (% by mass) | | | | | | | |
| (A)/(B) | | — | 10.00 | 4.00 | — | 4.00 | 4.00 |
| (A)/(C) | | — | — | — | — | 12.00 | 7.50 |
| ((A)/(100 parts by mass of meat)) | | — | 3.00 | 3.00 | — | 3.00 | 3.00 |
| ((A) + (B))/(X) | | — | 52.4% | 55.6% | — | 53.6% | 52.4% |
| Yield | Yield after soaking | 113% | 115% | 116% | 116% | 116% | 117% |
| | Yield after steaming | 62% | 66% | 70% | 67% | 71% | 69% |
| | Yield after cooking | 70% | 75% | 82% | 78% | 82% | 80% |
| Sensory | Initial chewiness | 2.0 | 3.0 | 3.7 | 3.3 | 3.7 | 3.0 |
| evaluation | Chewiness at time | 2.3 | 3.3 | 3.7 | 2.3 | 3.0 | 3.3 |
| | of chewing | | | | | | |
| | Dryness | 1.0 | 3.3 | 3.7 | 3.3 | 3.7 | 3.3 |
| | Taste | 4.0 | 3.7 | 3.7 | 2.0 | 3.0 | 3.0 |
| Workability | Dispersibility | 4 | 3 | 3 | 1 | 3 | 3 |
| | Redispersibility | 4 | 3 | 3 | 3 | 4 | 4 |

As seen from Table 7, the redispersibility was further improved in the liquid for meat processing, further including the component (C) in an amount of equal to or more than 0.25% by mass and equal to or less than 0.4% by mass, in addition to the components (A) and (B).

On the other hand, the liquid for meat processing, including the oil- or fat-processed starch 8, in which pH of the component (A) was out of the predetermined range, had poor dispersibility at the time of the production of the liquid for meat processing, and steamed prawns prepared by applying the liquid for meat processing to prawns, presented an unpleasant taste, which was thus unpreferable.

TABLE 8

| | | Control | | | | |
|---|---|---|---|---|---|---|
| Raw materials for | | Example | Example | Example | Example | Example |
| pickling liquid | | 5 | 6-1 | 6-2 | 6-3 | 6-4 |
| Powdery | (A) Oil- or fat- | | 3.00% | 3.00% | 3.00% | 3.00% |
| raw | processed starch 1 | | | | | |
| material | (B) Sodium hydrogen | | 1.00% | | | 0.40% |
| (X) | carbonate | | | | | |
| | (B) Potassium hydrogen | | | 1.00% | | |
| | carbonate | | | | | |
| | (B) Sodium | | | | 0.30% | 0.10% |
| | carbonate | | | | | |
| | Common salt | 3.00% | 3.00% | 3.00% | 3.00% | 3.00% |
| Ice water | | 97.00% | 93.00% | 93.00% | 93.70% | 93.50% |
| Total amount of pickling | | 100.00% | 100.00% | 100.00% | 100.00% | 100.00% |
| liquid (% by mass) | | | | | | |
| (A)/(B) | | — | 3.00 | 3.00 | 10.00 | 6.00 |
| ((A)/(100 parts by mass of meat)) | | — | 3.00 | 3.00 | 3.00 | 3.00 |
| ((A) + (B))/(X) | | — | 57.1% | 57.1% | 52.4% | 53.8% |
| Yield after soaking | | 112% | 115% | 116% | 116% | 116% |
| Yield after steaming | | 63% | 73% | 70% | 70% | 68% |
| Yield after cooking | | 70% | 83% | 82% | 81% | 79% |
| Sensory | Initial chewiness | 2.0 | 3.7 | 3.3 | 3.0 | 3.0 |
| evaluation | Chewiness at time | 2.3 | 4.0 | 3.7 | 3.3 | 3.7 |
| | of chewing | | | | | |
| | Dryness | 1.0 | 4.0 | 3.3 | 3.7 | 3.3 |
| | Taste | 4.0 | 3.7 | 2.7 | 2.7 | 3.0 |
| Workability | Dispersibility | 4 | 4 | 4 | 4 | 4 |
| | Redispersibility | 4 | 3 | 3 | 3 | 3 |

As seen from Table 8, steamed prawns obtained by applying a liquid for meat processing, including any one of sodium hydrogen carbonate, potassium hydrogen carbonate, and sodium carbonate as the component (B), together with the component (A), had a good texture and a good taste.

The initial chewiness was better in the order of sodium hydrogen carbonate, potassium hydrogen carbonate, and sodium carbonate as the component (B). As for the taste, sodium hydrogen carbonate was more natural, had no unpleasant taste, and was good.

In addition, it was found that good steamed prawns could also be obtained by applying the liquid for meat processing in which sodium hydrogen carbonate and sodium carbonate were mixed as the component (B).

TABLE 9

| Raw materials for pickling | | Control | |
|---|---|---|---|
| liquid (% by mass) | | Example 6 | Example 7 |
| Powdery | (A) Oil- or fat- | | 3% |
| raw | processed starch 1 | | |
| material | (B) Sodium hydrogen | | 1% |
| (X) | carbonate | | |
| | Polyphosphate | | |
| | Common salt | 3% | 3% |
| Ice water | | 97% | 97% |
| Total amount of pickling | | 100% | 100% |
| liquid (% by mass) | | | |
| (A)/(B) | | — | 3.0 |
| ((A)/(100 parts by mass of meat)) | | — | 1.2 |
| ((A) + (B))/(X) | | — | 57.1% |
| Yield | Yield after soaking | 110% | 118% |
| | Yield after steaming | 52% | 65% |
| | Yield after cooking | 57% | 77% |
| Sensory | Initial chewiness | 1.7 | 3.7 |
| evaluation | Chewiness at time | 4.0 | 3.3 |
| | of chewing | | |
| | Dryness | 2.0 | 4.0 |
| | Taste | 4.0 | 3.3 |
| Workability | Dispersibility | 4 | 4 |
| | Redispersibility | 4 | 3 |

As seen from Table 9, in Example 7, also in a case where a liquid for meat processing, including no phosphate, was applied to prawns by tumbling, steamed prawns having an excellent texture and an excellent taste could also be obtained in the same manner as in a case of performing standing and soaking.

More specifically, even in a case where the value of the component (A) per 100 parts by mass of meat was as small as 1.2 parts by mass, steamed prawns having good initial chewiness and suppressed dryness was obtained.

### Example 8, Comparative Examples 3 and 4, and Control Examples 7-1 and 7-2

In the present Examples, grilled chicken was prepared and evaluated.

A pickling liquid was prepared by blending raw materials other than ice water among the raw materials shown in each Example in Table 10, and mixing them to prepare a powder composition, and then mixing the composition with ice water. The production method and the evaluation method for the grilled chicken are shown below.

Method for Producing Grilled Chicken

Frozen chicken breast meat was thawed in a refrigerator (4° C.) from the previous day. After thawing, the skin of chicken breast meat was removed, tendered once on each side using a tenderizer (Rubshell, manufactured by Watanabe Foodmach Co., Ltd.), and cut into 25 g pieces.

On the other hand, the pickling liquid was mixed well based on the blending shown in Table 10 until there was no lump.

Twenty pieces of cut meat were placed in a laminated bag with a zipper (Lamizip LZ-22, manufactured by Seisan Nipponsha Ltd.), and the weight before tumbling was measured. Then, the pickling liquid was added to reach 40% of the meat mass, and the pressure was reduced with a vacuum packaging machine (manufactured by Hagios Co., Ltd.) for sealing. The conditions were set so that reduced pressure was kept for 20 seconds and sealing was performed at a medium temperature for 2 seconds.

After sealing, the bag was leveled and shaken to make the pickling liquid uniform. Then, the pickling liquid was tumbled at 4° C. for 120 minutes with a tumbler (RTN-VSQ0, manufactured by Daido Sangyo Co., Ltd.).

After tumbling, the contents of each bag were opened, the moisture content was removed, and then the weight after tumbling was measured.

After that, a net was placed on a shelf for a steam convection oven and the meat was lined up. Then, baking was performed in a steam convection oven (manufactured by Maruzen Co., Ltd.; SSC-03NSTU) in a steam combination mode at a set temperature of 200° C., 100% for 7 minutes to obtain grilled chicken. After allowing the grilled chicken to be left to be cooled, the weight after heat-cooking was measured.

(Calculation of Yield after Tumbling)

The yield after soaking was calculated from the weight before tumbling and the weight after tumbling, each obtained above, using the following equation.

Yield after tumbling (%)=Weight after tumbling/Weight before tumbling×100

(Calculation of Yield after Baking)

The yield after baking was calculated from the weight after tumbling and the weight after heat-cooking, each obtained above, using the following equation.

Yield after baking (%)=Weight after heat-cooking/Weight after tumbling×100

(Calculation of Yield after Cooking)

The yield after cooking was calculated from the yield after soaking and the yield after steaming, each obtained above, using the following equation.

Yield after cooking (%)=Yield after tumbling×Yield after baking/100

(Sensory Evaluation)

The grilled chicken obtained in each Example was sensorially evaluated by two professional panelists, based on the evaluation items and the scores shown in Table 2. Those with a score of more than 2 points were considered as acceptable.

(Evaluation of Workability)

For the pickling liquid of each Example, one operator evaluated the dispersibility at the time of the preparation of a pickling liquid and the redispersibility during soaking. For each evaluation item, those with a score of equal to or more than 2 points were considered as acceptable.

TABLE 10

| | | Control | Comparative | Control | Comparative | |
|---|---|---|---|---|---|---|
| Raw materials for | | Example | Example | Example | Example | Example |
| pickling liquid | | 7-1 | 3 | 7-2 | 4 | 8 |
| Powdery | (A) K-1 | | 6.70% | | | 5.40% |
| raw | (B) Sodium hydrogen | | | | 1.00% | 0.50% |
| material | carbonate | | | | | |
| (X) | (C) Pregelatinized | | 2.80% | | | 2.20% |
| | high-amylose corn | | | | | |
| | starch | | | | | |
| | Polyphosphate | | | 3.00% | | |
| | Caster sugar | 2.00% | 2.00% | 2.00% | 2.00% | 2.00% |
| | Common salt | 2.00% | 2.00% | 2.00% | 2.00% | 2.00% |
| | Na glutamate | 0.60% | 0.60% | 0.60% | 0.60% | 0.60% |
| Ice water | | 95.40% | 85.90% | 92.40% | 94.40% | 87.30% |
| Total amount of pickling | | 100.00% | 100.00% | 100.00% | 100.00% | 100.00% |
| liquid (% by mass) | | | | | | |
| (A)/(B) | | — | — | — | — | 10.80 |
| (A)/(C) | | — | 2.39 | — | — | 2.45 |
| ((A)/(100 parts by mass of meat)) | | — | 2.68 | — | — | 2.16 |
| ((A) + (B))/(X) | | — | — | — | — | 46.5% |
| Yield | Yield after tumbling | 117% | 119% | 131% | 115% | 113% |
| | Yield after baking | 59% | 74% | 78% | 66% | 72% |
| | Yield after cooking | 69% | 87% | 103% | 76% | 81% |
| Sensory | Initial chewiness | 2 | 3 | 4 | 4 | 4 |
| evaluation | Chewiness at time | 2 | 2 | 1 | 2 | 4 |
| | of chewing | | | | | |
| | Dryness | 1 | 4 | 4 | 2 | 4 |
| | Taste | 4 | 4 | 4 | 2 | 4 |
| Workability | Dispersibility | 4 | 4 | 4 | 4 | 4 |
| | Redispersibility | 4 | 4 | 4 | 4 | 4 |

As seen from Table 10, also in a case where the liquid for meat processing of the present Example was applied to a single piece of meat such as chicken breast meat, grilled chicken having an excellent texture and an excellent taste could be obtained. In addition, it was found that in a case where the liquid for meat processing of the present Example was applied, a good food could be obtained even by baking.

More specifically, the grilled chicken of Examples was felt meaty and preferable in terms of the initial chewiness and the chewiness at the time of chewing. On the other hand, in Control Examples using phosphate, the initial chewiness was excellent, but the chewiness at the time of chewing was uniform, was not felt meaty and was inferior.

### Example 9, and Control Examples 8-1 and 8-2

In the present Examples, deep-fried prawns were prepared and evaluated. The pickling liquid was prepared by blending and mixing the raw materials shown in each Example of Table 11. The production method and the evaluation method of the deep-fried prawns are shown below.

(Method for Producing Deep-fried Prawns)

As raw material prawns, the same kind of prawns as those used for producing the steamed prawns was used.

On the other hand, among the raw materials for the pickling liquid, the component (A), the component (B), and common salt were mixed to prepare a composition for a liquid for meat processing. This composition for a liquid for meat processing was combined with ice water and suspended.

After preparing the pickling liquid, the prawns were soaked in an equivalent amount of the pickling liquid overnight at 4° C. After soaking, the yield after soaking was calculated by the same method as in the method for producing the steamed prawns.

Then, a batter liquid and bread crumbs were applied in this order to the outside of the prawns, and deep-fried in canola oil at 175° C. for 3 minutes. The blending of the batter liquid is shown below.

| Raw material for batter liquid | parts by mass |
|---|---|
| oil- or fat-processed starch 4 | 97.0 |
| Common salt | 2.0 |
| Na glutamate | 1.0 |
| White pepper | 0.5 |
| Xanthan gum | 0.4 |
| Cold water | 200.0 |

The fried prawns after deep-frying were sensorially evaluated by five professional panelists, based on the evaluation items and the scores shown in Table 2. Those with a score of more than 2 points were considered as acceptable.

In addition, the workability was evaluated by one operator, based on the evaluation items and the scores shown in Table 2. For each evaluation item, those with a score of equal to or more than 2 points were considered as acceptable.

TABLE 11

| | | Control | Control | |
|---|---|---|---|---|
| Raw materials for | | Example | Example | Example |
| pickling liquid | | 8-1 | 8-2 | 9 |
| Powdery | (A) Oil- or fat- | | | 1.00% |
| raw | processed starch 1 | | | |
| material | (B) Sodium | | | 1.00% |
| (X) | hydrogen | | | |
| | carbonate | | | |
| | Polyphosphate | | 1.00% | |
| | Common salt | 2.00% | 2.00% | 2.00% |
| Ice water | | 98.00% | 97.00% | 96.00% |
| Total amount of pickling | | 100.00% | 100.00% | 100.00% |
| liquid (% by mass) | | | | |
| (A)/(B) | | — | — | 1.00 |
| ((A)/(100 parts by mass | | — | — | 1.00 |
| of meat)) | | | | |
| ((A) + (B))/(X) | | — | — | 50.0% |
| Yield | Yield after | 108% | 115% | 114% |
| | soaking | | | |
| | Yield after | 83% | 87% | 88% |
| | frying | | | |
| | Yield after | 90% | 100% | 100% |
| | cooking | | | |
| Sensory | Initial chewiness | 2 | 3 | 4 |
| evaluation | Chewiness at time | 3 | 1 | 4 |
| | of chewing | | | |
| | Dryness | 1 | 3 | 3 |
| | Taste | 4 | 4 | 4 |
| Work- | Dispersibility | 4 | 4 | 4 |
| ability | Redispersibility | 4 | 4 | 3 |

As seen from Table 11, the fried prawns cooked by deep-frying the prawns, to which the liquid for meat processing of the present Example had been applied, were very good. That is, it was found that in a case where the liquid for meat processing of the present Example was applied, a good food could be obtained even with a heating method which was deep-frying.

The present application claims priority on the basis of Japanese Patent Application No. 2018-185925 filed on September 28, 2018, the contents of which are incorporated herein by reference in its entirety.

1. A liquid for meat processing, comprising the following components (A) and (B):
(A) an oil- or fat-processed starch; and
(B) one or more alkali agents selected from the group consisting of sodium hydrogen carbonate, sodium carbonate, potassium hydrogen carbonate, and potassium carbonate,
wherein a pH of a 10% by mass aqueous dispersion of the component (A) at 25° C. is equal to or more than 4.0 and equal to or less than 12.0.

2. The liquid for meat processing according to claim 1,
wherein a phosphate is not substantially included.

3. The liquid for meat processing according to claim 1,
wherein a content of the component (A) with respect to a content of the component (B) is equal to or more than 0.1 and equal to or less than 40 in terms of a mass ratio.

4. The liquid for meat processing according to claim 1,
wherein the component (A) is an oil- or fat-processed distarch phosphate from tapioca starch.

5. The liquid for meat processing according to claim 1,
wherein the component (B) is sodium hydrogen carbonate.

6. The liquid for meat processing according to claim 1, further comprising a component (C): a pregelatinized starch.

7. The liquid for meat processing according to claim 6,
wherein a content of the component (A) with respect to a content of the component (C) is equal to or more than 1 and equal to or less than 40 in terms of a mass ratio.

8. The liquid for meat processing according to claim 1,
wherein the meat is one or more selected from the group consisting of chicken, pork, beef, prawns, white fish, squid, and scallops.

9. A powdery composition for a liquid for meat processing, comprising the following components (A) and (B):
(A) an oil- or fat-processed starch; and
(B) one or more alkali agents selected from the group consisting of sodium hydrogen carbonate, sodium carbonate, potassium hydrogen carbonate, and potassium carbonate,
wherein a pH of a 10% by mass aqueous dispersion of the component (A) at 25° C. is equal to or more than 4.0 and equal to or less than 12.0.

10. The composition for a liquid for meat processing according to claim 9,
wherein the component (A) and the component (B) are contained in a total amount of equal to or more than 25% by mass and equal to or less than 100% by mass with respect to the entire composition for meat processing.

11. The composition for a liquid for meat processing according to claim 9,
wherein a content of the component (A) with respect to a content of the component (B) in the composition for meat processing is equal to or more than 0.1 and equal to or less than 40 in terms of a mass ratio.

12. The composition for a liquid for meat processing according to any claim 9, further comprising a component (C): a pregelatinized starch.

13. (currently amended I) The composition for a liquid for meat processing according to claim 12,
wherein a content of the component (A) with respect to a content of the component (C) is equal to or more than 1 and equal to or less than 40 in terms of a mass ratio.

14. A method for producing a meat processed food, comprising applying a liquid for meat processing, including the following components (A) and (B), to meat:
(A) an oil- or fat-processed starch; and
(B) one or more alkali agents selected from the group consisting of sodium hydrogen carbonate, sodium carbonate, potassium hydrogen carbonate, and potassium carbonate,
wherein a pH of a 10% by mass aqueous dispersion of the component (A) at 25° C. is equal to or more than 4.0 and equal to or less than 12.0.

15. The method for producing a meat processed food according to claim 14,
wherein a content of the component (A) with respect to a content of the component (B) in the liquid for meat processing is equal to or more than 0.1 and equal to or less than 40 in terms of a mass ratio.

16. The method for producing a meat processed food according to claim 14,
wherein the applying the liquid for meat processing to meat is applying the liquid for meat processing to meat by one or more methods selected from the group consisting of injection, tumbling, soaking, spraying, and coating.

17. The method for producing a meat processed food according to claim 14,
wherein in the applying the liquid for meat processing to meat, the liquid for meat processing is applied so that an amount of the component (A) to be added with respect to 100 parts by mass of the meat is equal to or more than 0.1 parts by mass and equal to or less than 20 parts by mass in terms of a mass ratio.

18. The method for producing a meat processed food according to claim 14,
wherein the meat processed food is selected from the group consisting of grilled chicken, karaage, steamed prawns, and fried prawns.

19. A method for improving chewiness of a meat processed food, comprising incorporating a liquid for meat processing into meat in production of the meat processed food, the meat processed food including the following components (A) and (B):
(A) an oil- or fat-processed starch; and
(B) one or more alkali agents selected from the group consisting of sodium hydrogen carbonate, sodium carbonate, potassium hydrogen carbonate, and potassium carbonate,
wherein a pH of a 10% by mass aqueous dispersion of the component (A) at 25° C. is equal to or more than 4.0 and equal to or less than 12.0.
